(19) United States
(12) Patent Application Publication
(10) Pub. No.: US 2016/0165376 A1
(43) Pub. Date: Jun. 9, 2016

(54) METHOD AND SYSTEM FOR EXPLICIT EXCLUSION, INCLUSION AND RANKING OF DISCOVERY AND CONNECTIVITY MECHANISMS

(71) Applicant: Intel Corporation, Santa Clara, CA (US)

(72) Inventors: Emily H. Qi, Camas, WA (US); Carlos Cordeiro, Portland, OR (US); David J. McCall, Dallas, TX (US)

(21) Appl. No.: 14/671,405

(22) Filed: Mar. 27, 2015

Related U.S. Application Data
(60) Provisional application No. 62/088,391, filed on Dec. 5, 2014.

(51) Int. Cl. H04W 4/00; H04W 76/02; H04L 29/08

(52) U.S. Cl. CPC H04W 4/003; H04L 67/16; H04W 76/023

(57) ABSTRACT

The disclosure relates to a method, apparatus and system to enable exclusion, inclusion and ranking of discovery and connectivity mechanisms for services using Application Services Platform (ASP). In on embodiment, the disclosure provides an interface to allow services to exclude some discovery and connectivity mechanisms from and ASP2 session setup. The proposed approach can be used or extended for any other out-of-band Wi-Fi/WiGig discovery, connectivity and security mechanism.

### CROSS REFERENCE

This application claims the filing-date benefit and priority from U.S. Provisional Patent Application No. 62/088,391 entitled “Method and System for Explicit Exclusion, Inclusion and Ranking of Discovery and Connectivity Mechanisms”, filed Dec. 5, 2014, the disclosure of which is incorporated herein in its entirety.

### BACKGROUND

1. Field

The disclosure generally relates to a method, apparatus and system to enable exclusion, inclusion and ranking of discovery and connectivity mechanisms for services using Application Services Platform (ASP). Specifically, certain disclosed embodiments provide a method and system to selectively rank ASP discovery, connectivity and security modes.

2. Description of Related Art

Wireless communication devices are designed to provide one or more services to other wireless devices. For example, the first wireless communication device may provide printing services, display services, internet access services, and/or any other service to other wireless communication devices. Wireless Fidelity (Wi-Fi) Direct technology provides Peer-to-Peer (P2P) connectivity to connect different wireless devices to provide services (e.g., to share, to print, to display or to access the internet). Wi-Fi Direct technology provides Link layer connectivity between wireless devices. A Wi-Fi Direct device may, for example, connect to the internet through a Wi-Fi direct laptop computer which may act as an Access Point (AP). Wi-Fi Direct technology does not support interoperability between services and/or application from multiple vendors.

Application Services Platform (ASP), in its various versions, is a tool for developing and deploying new applications. The underlying platform enables developers to create custom applications using a standard user interface and data model. The ASP enables accelerated, customized, automated and standardized application development models while minimizing the development cost.

The conventional Application Services Platform (ASP, ASP2) extends Wi-Fi Direct discovery to make use of Neighborhood Area Networking (NAN), Bluetooth (BT), Bluetooth Low Energy (BLE), Near Field Communication (NFC). The conventional ASPs also extend Wi-Fi Direct connectivity to Wi-Fi infrastructure. Accordingly, two devices may use BLE to discover each other and then set up a data session over the Wi-Fi infrastructure.

Conventional ASPs do not allow the programmer to independently select and task the program for detection, connection and security settings. Instead, these services are automatically dictated and selected by the environment.

Because there are occasions where the application's need may dictate specific forms of, among others, discovery and connection mechanisms, there is a need for a system and method to enable explicit exclusion, inclusion and ranking of discovery and connectivity mechanisms, among other features, for services using ASP.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a schematic block diagram illustration of a system for implementing an embodiment of the disclosure;

FIG. 2 illustrates a conventional ASP2 program infrastructure;

FIG. 3 illustrates an exemplary API implementation according to one embodiment of the disclosure;

FIG. 4 illustrates a bit map setting according to one embodiment of the disclosure; and

FIG. 5 shows an exemplary apparatus for implementing an embodiment of the disclosure

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items. References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

As used herein service discovery is a wireless communication method that enables a wireless communication device to find a service provided by another wireless communication device. For example, a mobile device (e.g., smartphone) having no printing capability may seek a service (e.g., printing service) from a printer to print an item (e.g., a document or a picture) from the mobile device. In this example, the mobile device may use service discovery to find a service provided by the printer in order to print the item. Some conventional service discovery methods include Universal Plug and Play (UPnP), Bonjour, and others. In some cases, using conventional service discovery methods in some wireless networks may cause communication traffic congestion, increased power consumption, or both.

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless AP, a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec., 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HDTM specifications and/or future versions and/or derivatives thereof, units and/or devices which are part of the above networks, and the like.

Some embodiments may be implemented in conjunction with the BT and/or Bluetooth low energy standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a piconet, a WPAN, a WVAN and the like.

An embodiment of the disclosure is directed to providing connection services and mechanism to allow applications and services to specify what type of discovery and network topology to use in P2P connection set up and communication. In certain embodiments, the proposed principles provides data that needs to be processed at the application and services level in the context of what the application and services accomplish in order to determine how to discover and how to connect to the discovered device as to enhance the user experience.

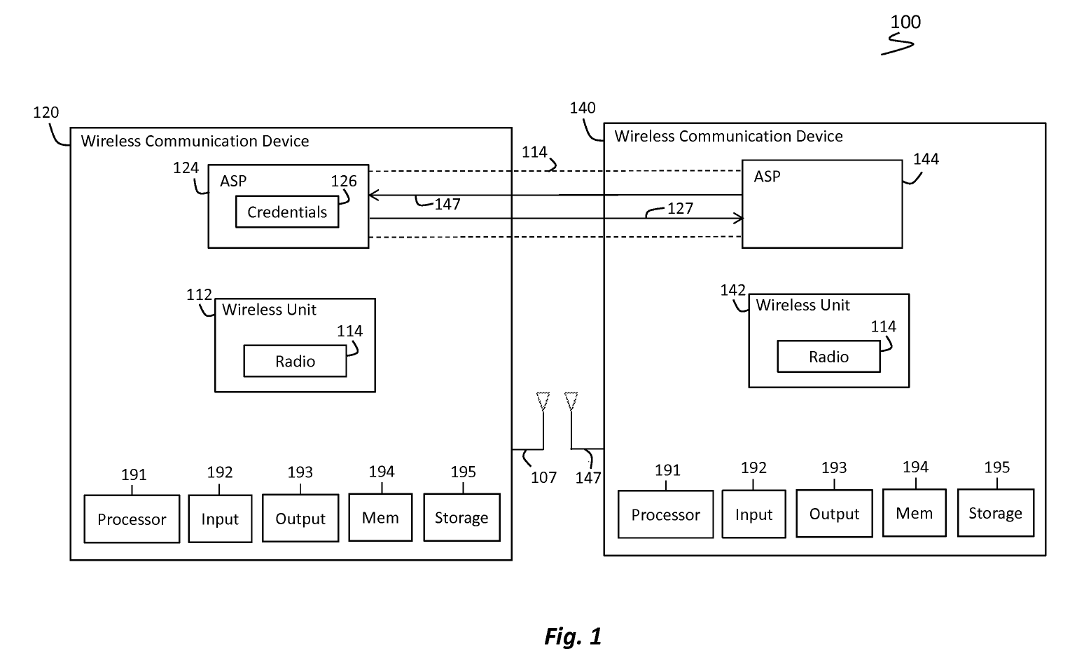

FIG. 1 is a schematic block diagram illustration of a system for implementing an embodiment of the disclosure. System 100 of FIG. 1 may include a wireless communication network including one or more wireless communication devices, e.g., wireless communication devices 120 and/or 140, capable of communicating content, data, information and/or signals over a wireless communication medium (WM), for example, a radio channel, an IR channel, an RF channel, a Wireless Fidelity (Wi-Fi) channel, and the like. One or more elements of system 100 may optionally be capable of communicating over any suitable wired communication links.

In some embodiments, wireless communication devices 120 and/or 140 may include, for example, a PC, a desktop computer, a mobile computer, a laptop computer, a notebook computer, a tablet computer, an Ultrabook™ computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

Wireless communication devices 120 and/or 140 may include wireless communication units 112 and/or 142, respectively, to perform wireless communication between wireless communication devices 120 and/or 140 and/or with one or more other wireless communication devices as described below. In some demonstrative embodiments, wireless communication devices 120 and/or 140 may also include, for example, one or more of a processor 191, an input unit 192, an output unit 193, a memory unit 194, and a storage unit 195. Wireless communication devices 120 and/or 140 may optionally include other hardware components and/or software components. In some demonstrative embodiments, some or all of the components of one or more of wireless communication devices 120 and/or 140 may be enclosed in a common housing or packaging, and may be interconnected or operably associated using one or more wired or wireless links. In other embodiments, components of one or more of wireless communication devices 120 and/or 140 may be distributed among multiple or separate devices.

Processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of wireless communication devices 120 and/or 140 and/or of one or more applications.

Input unit 192 includes, for example, a keyboard, a keypad, a mouse, a touch-screen, a touch-pad, a track-ball, a stylus, a microphone, or other suitable pointing device or input device. Output unit 193 includes, for example, a monitor, a screen, a touch-screen, a flat panel display, a Cathode Ray Tube (CRT) display unit, a Liquid Crystal Display (LCD) display unit, a plasma display unit, one or more audio speakers or earphones, or other suitable output devices.

Memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 includes, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by wireless communication devices 120 and/or 140.

In some demonstrative embodiments, wireless communication units 112 and/or 142 may include, or may be associated with, one or more antennas 107 and/or 147, respectively. Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a phased array antenna, a single element antenna, a set of switched beam antennas, and/or the like. In some embodiments, antennas 107 and/or 147 may implement transmit and receive functionalities using separate transmit and receive antenna elements. In some embodiments, antennas 107 and/or 147 may implement transmit and receive functionalities using common and/or integrated transmit/receive elements.

In some demonstrative embodiments, wireless communication units 112 and/or 142 include, for example, one or more radios 114, e.g., including one or more wireless transmitters, receivers and/or transceivers able to send and/or receive wireless communication signals, RF signals, frames, blocks, transmission streams, packets, messages, data items, and/or data. For example, wireless communication units 112 and/or 142 may include or may be implemented as part of a wireless Network Interface Card (NIC), and the like.

In some demonstrative embodiments, wireless communication medium (not shown) may include a wireless P2P link. For example, devices 120 and/or 140 may perform the functionality of a P2P client or a P2P group owner (GO). In some demonstrative embodiments, wireless communication medium (not shown) may include a Wi-Fi direct link. In some demonstrative embodiments, wireless communication medium (not shown) may include any other suitable link.

In some demonstrative embodiments, devices 120 and/or 140 may be configured to provide one or more services to one or more remote devices. For example, device 120 may be configured to provide printing services, display services, Internet access services and/or any other services to device 140. In some embodiments, devices 120 and/or 140 may be configured to advertise the one or more services, for example, to enable the remote devices to find the services. For example, device 120 may be configured to advertise one or more of the services provided by device 120 to enable device 140 to discover the services provided by device 120. In some embodiments, devices 120 and/or 140 may be configured to utilize the one or more services from the remote devices. For example, device 140 may be configured to utilize the services from device 120. In some demonstrative embodiments, devices 120 and/or 140 may be configured to connect to a device to receive the service provided by the device. For example, device 140 may be configured to connect to device 120 to receive the services provided by device 120. In some demonstrative embodiments, devices 120 and 140 may establish a P2P connection between devices 120 and 140 over wireless communication medium (not shown) to connect between devices 120 and 140, and to provide the one or more services between devices 120 and 140. In some demonstrative embodiments, devices 120 and 140 may establish any other connection between devices 120 and 140 over wireless communication medium (not shown).

Devices 120 and/or 140 may include an Application Service Platform (ASP) configured to manage the procedure of receiving and/or providing the one or more services, e.g., according to a predefined protocol. In some embodiments, device 120 may include an ASP 124, and/or device 140 may include an ASP 144, configured to manage an ASP-session between devices 120 and 140. Each of ASP 124 or ASP 144 may include a software module (not shown) and/or a library module (not shown) that implements functions required for managing the procedure of receiving and/or providing the one or more services. For example, the functions may include discovery of a service, session management, connection topology management, security management and/or any other function to support management of the services. In other embodiments, ASP 124 and/or ASP 144 may be implemented using any other module and/or configuration.

In some demonstrative embodiments, ASP 124 and ASP 144 may be configured to establish one or more ASP-sessions between devices 120 and 140 over the P2P connection. The ASP-session may be utilized, for example, to provide the one or more services between devices 120 and 140. In some demonstrative embodiments, an ASP-session may include a logical link between ASP 124 and 144, e.g., over the P2P connection between devices 120 and 140. The ASP-session may be configured, for example, to manage the procedure of providing a service between devices 120 and 140. In some demonstrative embodiments, ASP 124 and/or ASP 144 may not be able to establish the one or more ASP-sessions, for example, if devices 120 and/or 140 do not establish the P2P connection between devices 120 and/or 140, e.g., prior to establishing the ASP-sessions. In other embodiments, ASP 124 and/or ASP 144 may not be able to establish the one or more ASP-sessions over the P2P connection, for example, if devices 120 and 140 are not part of an ASP-P2P group. In still other embodiments, ASP 124 and/or 144 may setup an ASP-P2P group between ASP 124 and ASP 144 to establish the ASP-session and/or the P2P connection between ASP 124 and 144. In some demonstrative embodiments, the ASP-P2P group may include a group formed by an ASP (e.g., ASP 124 and/or 144) and may include a set of devices including a P2P group owner (GO) and zero or more clients. For example, the ASP-P2P group may include one of device 120 to perform the GO functionality while device 140 performs client functionality.

In some demonstrative embodiments, establishing the ASP-session between devices of the ASP-P2P group may require users of the devices to perform a provisioning procedure. For example, the users of the one or more devices of the ASP-P2P group may perform the provisioning procedure to assure that the correct devices are forming the ASP-P2P group. The devices may utilize a Wi-Fi simple configuration (WSC) procedure to perform the provisioning procedure. In some embodiments, ASP 124 and/or ASP 144 may form one or more ASP-P2P groups based on one or more requests to establish one or more ASP-sessions. In one example, ASP 124 and/or ASP 144 may establish the one or more ASP-sessions between devices 120 and 140 to provide one or more services between devices 120 and 140. ASP 124 and ASP 144 may exchange credentials, e.g., during a provisioning phase. The credentials may include information, which may be required to join an ASP-P2P group. For example, the credentials may include a data structure, which may enable gaining access to the ASP-P2P group. In one example, the credentials may include, for example, a Wi-Fi Protected Access (WPA) personal pre-shared key (PSK). In other embodiments, the credentials may include any other data and/or information. In one embodiment, a persistent group may be a P2P group between a first and second devices in which credentials are stored by the first and/or the second devices and may be made available for reuse after an initial use, e.g., of an ASP-session. The persistent group may have a lifetime, which may extend over a number of distinct ASP-sessions after the initial use until the persistent group is deliberately dissolved, e.g., by ASP 124 and/or 144.

Conventional ASP/ASP2 systems do not provide programming freedom in selecting discovery and connection mechanism for the application under development. Accordingly, by default, a service is directed to use all discovery mechanisms and connectivity mechanisms to set up an ASP sessions. For example, an ASP session may be set up over the network or non-IP network. For certain applications, it may be preferable to establish the session over an IP network session. In other applications, however, it may be desirable to avoid certain specific discovery mechanism, connectivity mechanism, or network type (IP or non-IP) for the ASP session. In another example, a service (e.g., file send between P2P devices) may not want to use existing AP infrastructure discovery or use existing AP infrastructure connectivity to setup an ASP session. The conventional ASP2 infrastructure does not provide application programmer the option of selecting discovery mechanism, connectivity mechanism and network type.

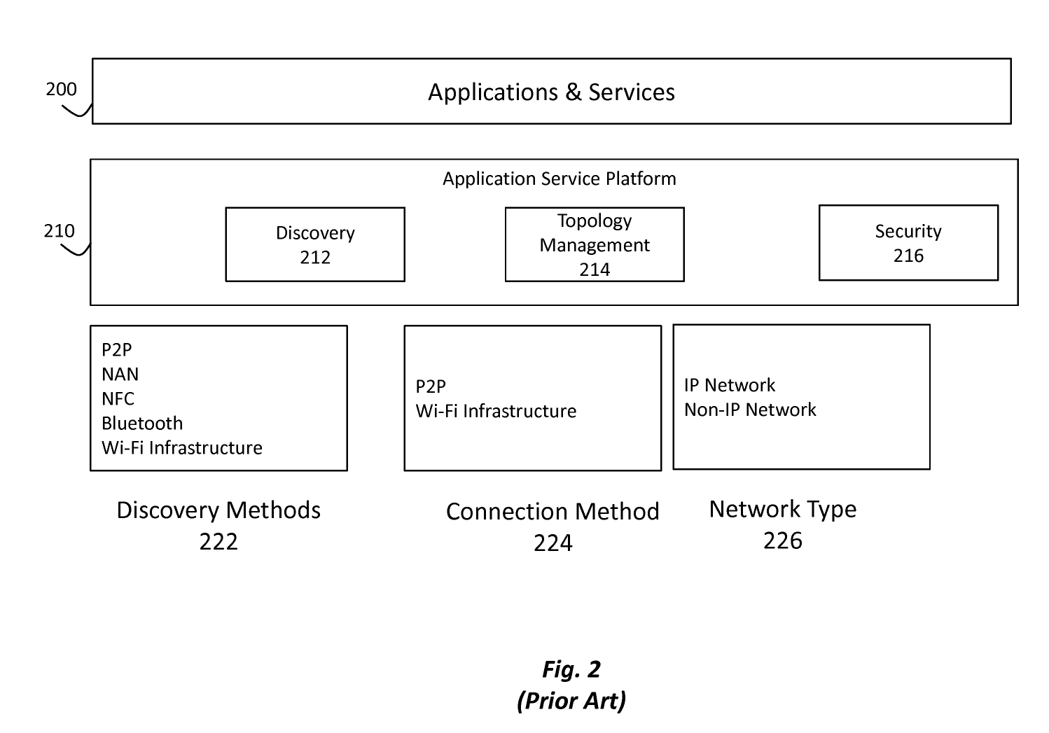

FIG. 2 illustrates a conventional ASP2 program infrastructure. Specifically, FIG. 2 shows Application and Services 200, Application Service Platform 210 (functions provided by the application) and functional groups 222, 224 and 226. In an exemplary embodiment, ASP 200 denotes an environment for ASP 210.

Application Service Platform 210 manages functions provided by the application or applet (App). Application service platform 210 includes discovery 212, topology management 214 and security 216. Discovery 212 is identifies nearby devices and other signal transmitters. Nearby devices may include displays, printers, other mobile devices, etc. Nearby devices may regularly transmit signals, such as BLE advertisement, which may be detected by a device hosting ASP 210.

Discovery 212 my include P2P discovery, NAN, NFC, Bluetooth or Wi-Fi infrastructure discovery mechanism. Discovery method discovers services such as printing and docking stations. Topology management 214 determines whether, for example, P2P connection or the Wi-Fi (AP) infrastructure connection may be used. The AP infrastructure may include unique Wi-Fi security for each wireless AP. For certain applications, it may be desirable to not have the option of using P2P. Network topology management covers connection methods 224 and network type 226. Exemplary connection methods include, P2P connection, or W-Fi infrastructure. Exemplary network types include IP network and non-IP network. Security portion 216 determines which provisioning mechanism may be used. The conventional ASP2 systems automatically selects all available options on these and other categories. For example, the conventional ASP2 selects all available discovery methods. Consequently, an application service provider (e.g., ASP 210) will automatically apply all discovery methods to the application or applet. The automatic application of all discovery, topology and security mechanism has undesirable side effects such as long discovery latency, inefficient medium use (i.e., large overhead management frame exchange requirement) and inefficient battery use.

In one embodiment, the disclosure provides an interface to allow services to exclude, include or optionally select some discovery mechanisms, connectivity mechanisms, and Network types from ASP2 session setup. The disclosed principles may be equally applied to ASP2. The disclosed embodiments may be equally implemented by, or extended to, other out-of-band Wi-Fi/Wi-Gig Apps requiring discovery, connectivity, network type and security mechanism.

In one embodiment, the disclosure provides data to be processed at application/service level in the context of what the application/service accomplishes in order to determine how to discover and connect to the discovered device in order to improve the user experience. Among others, the disclosed embodiments, reduce the number of management frames used by Wi-Fi for device/service discovery. The disclosed embodiments provide significantly faster discovery and connection mechanism, resulting in faster ASP session establishment. The disclosed embodiments extend battery life because of low power discovery mechanisms.

In one embodiments, the disclosure provides one or more primitive applications (interchangeably, primitive(s)) or program interface (API) to allow a service to specify which mechanism to include or exclude. In certain embodiments, the detection and connection mechanisms are ranked according to preference or other desired criteria. The ranking may be dynamic to allow changes in the desired selection rank to thereby allow flexibility to accommodate an environment.

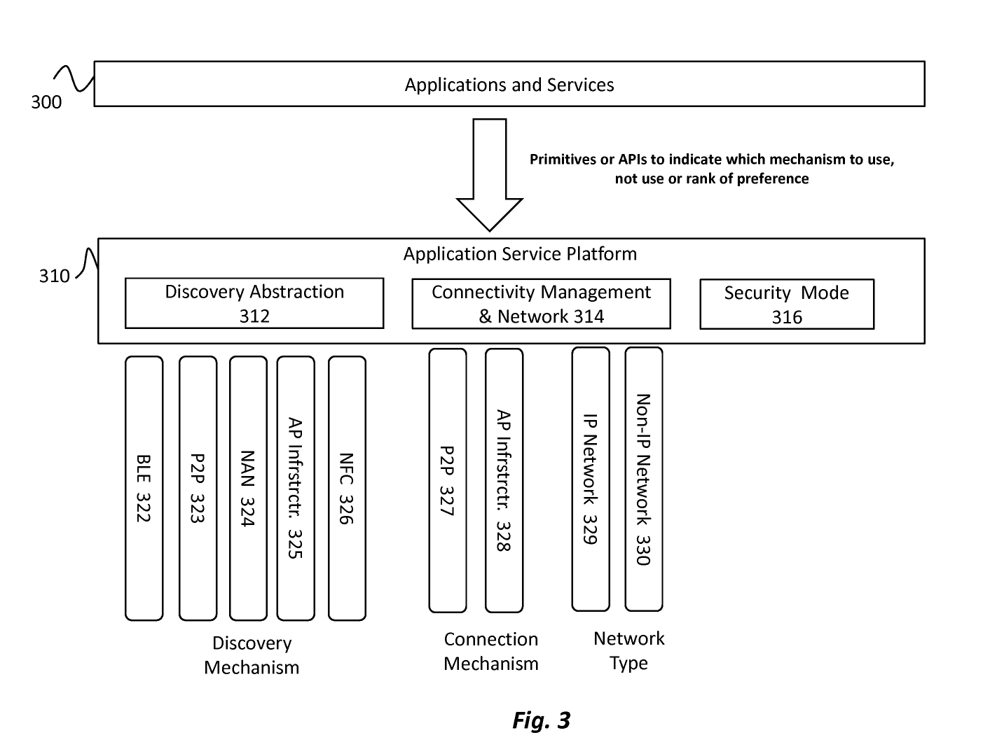

FIG. 3 illustrates an exemplary primitive or API according to one embodiment of the disclosure. In FIG. 3, Application and Services 300 may communicate one or more primitives or an API to Application Service Platform 310. Platform 310 is shown with exemplary Discovery Abstraction 312, Connectivity Management and Network type 314 and Security Abstraction 316. The primitive programs or the API may provide an option to the programmer as to different selection options. While FIG. 3 shows the options in terms of discovery mechanism, connection mechanism and network type, other selective options may be included without departing from the disclosed principles. The API may allow programmer to decide appropriate mechanism to be included, excluded or to ranked in terms of preferences. The options may be selected to complement the underlying application and in order to improve its connectivity and performance.

By way of example, the following three examples are presented to illustrate different embodiment of the disclosure. In each example a primitive program and/or API may be presented to the programmer to allow option selection. In the first exemplary embodiment, an exclusive primitive program or an API may be provided from Applications and Services 300 to Application Service Platform 310. Under the exclusive option, a set of default discovery and connectivity management mechanism may be presented by Applications and Services 300. For example, ASP and ASP2 may be set to use all available mechanisms by default.

Under the so-called exclusive option embodiment, the primitive and/or the API specifies which mechanisms should be excluded. By way of example, the primitive and/or API may exclude P2P 323, NAN 324 and NFC 326 from the Discovery Mechanism choices. The primitive and/or API may also exclude P2P 327 Connection Mechanism and leave only the AP Infrastructure 328 as the available connectivity mode. The network type may optionally be excluded entirely or only one network type (e.g., IP Network 329 or Non-IP Network 330) may be selected.

The second exemplary option (inclusive) may set default ASP (or ASP2) to use none of the mechanism. Instead, the primitive program and/or the API may specify which mechanism may be used. Under this implementation, Applications and Services 300 may exclude all Discovery Abstraction Mechanisms, Connectivity Management, Network type and Security Mode 316 options. Here, the programmer may specify which mechanisms should be included.

By way of example, the primitive program and/or API may include BLE 322, AP Infrastructure 325, P2P 323 and NFC 326 Discovery Mechanisms along with P2P 327 Connection Mechanism. Similar decisions may be made with respect to the Network Type or Security Mode 316.

The third exemplary embodiment (preference ranking) may provide a preference order for the applied mechanism within each category. For example, the programmer may utilize the API to use P2P 322 Discovery Abstraction first. If P2P 322 is unavailable, then the next Discovery Preference may be NAN 324. In the event the that NAN Discovery Mechanism 324 is unavailable, then one of NFC 326 or BLE 322 Discovery Mechanisms may be used. Similar preference ranking may be applied to Connectivity Management and Security Mode.

In one embodiment, a selection in one mechanism category may dictated the preference in other categories. For example, the primitive and/or API may designate a rule that if AP infrastructure 325 Discovery Mechanism is used, then AP Infrastructure 328 Connectivity Mode must also be used. It may also designate a preference that when AP Infrastructure 325 Discovery or AP Infrastructure 328 Connectivity Modes are used, the IP network Security Mode must be modified accordingly. The selected mechanism and modality enables associating suitable discovery and connection mechanism to each App.

The primitive and/or the program may be communicated from Applications and Services 300 to Application Service Platform 310 in two-byte bitmap. In one embodiment, the selection of the appropriate bites in the bitmap determines the selected options for inclusion, exclusion or discovery and connection preferences. In the bitmap definition of the first exemplary embodiment (i.e., exclusive), the corresponding bit may be set to 1 to indicate to not use an associated mechanism. Otherwise, the it may be used if ASP supports the selected mechanism. TABLE 1 provides an exemplary bitmap setting for implementing Option 1. The bitmap of TABLE 1 may be included in the primitives or the API which was directed to Application Service Platform 310 by Applications and Services 300.

TABLE 1
Exemplary Bitmap Definition for Option 1 (Exclusive)

| | Description: |
|---|---|
| | Set to 1 indicates to not use. |
| Bits | Otherwise, it may be used if ASP supports |
| 0 | P2P Discovery bit. |
| 1 | NAN Discovery bit. |
| 2 | AP Infrastructure Discovery bit. |
| 3 | BLE Discovery bit. |
| 4 | NFC Discovery bit. |
| 5-7 | Reserved for future extension. |
| 8 | P2P Connectivity bit |
| 9 | AP Infrastructure bit. |
| 10 | ASP session over IP bit |
| 11 | ASP session over non-IP bit |
| 12-15 | Reserved for future extension |

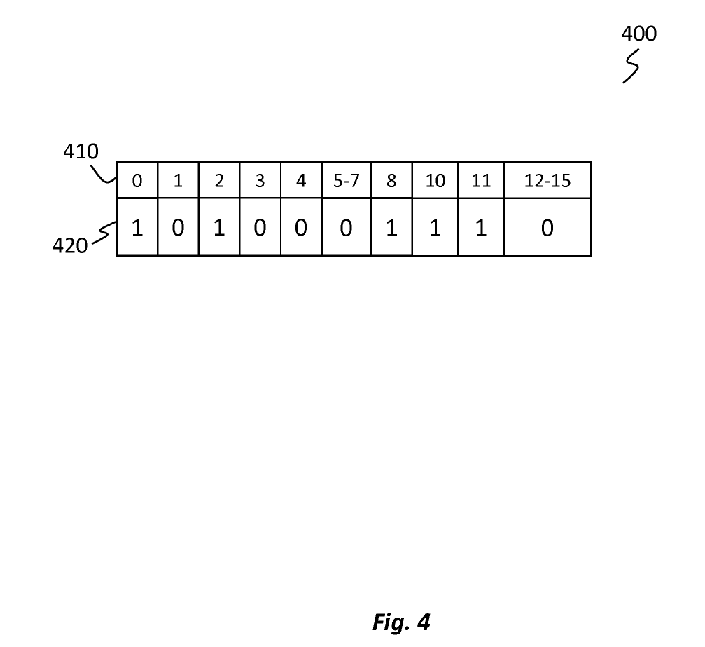

FIG. 4 illustrates a bit map setting according to one embodiment of the disclosure. The bit map 400 of FIG. 4 shows bit numbers at row 410. Each bit may be set as a mode zero or one as shown in row 420. The function of each bit is disclosed in FIG. 1.

In the bitmap definition of the second exemplary embodiment (i.e., inclusive), the corresponding bit set to one (1) indicates the mechanism is to be used. A bit set to zero (0) indicates that the mechanism is not to be used. TABLE 2 provides an exemplary bitmap setting for implementing the second exemplary embodiment.

TABLE 2
Exemplary Bitmap Definition for Option 2 (Inclusive)

| | Description: |
|---|---|
| | Set to 1 indicates to use. |
| Bits | Otherwise, do not use |
| 0 | P2P Discovery bit |
| 1 | NAN Discovery bit |
| 2 | AP Infrastructure Discovery bit |
| 3 | BLE Discovery bit |
| 4 | NFC Discovery bit |
| 5-7 | Reserved for future extension. |
| 8 | P2P Connectivity bit |
| 9 | AP Infrastructure bit |
| 10 | ASP session over IP bit |
| 11 | ASP session over non-IP bit |
| 10-15 | Reserved for future extension |

In another implementation, a four-byte bitmap may be used to indicate the order of preference for each mechanism. This implementation is may be applied to the third exemplary embodiment referenced above (i.e., ranked preference). Here, a two-bits value may be assigned to each mechanism. Higher value may indicate a more preferred mechanism. For example, value three (3) may be represented as (11) to denote the most preferred value while value zero (0) denoted as (00) may be associated with the desire not to use. TABLE 3 provides an exemplary bitmap setting for implementing the ranked preference embodiment.

TABLE 3
Exemplary bitmap definition for preference ranking

| | Description: |
|---|---|
| | Higher value indicates higher preference |
| | The value “3” = the most preferred. |
| Bits | The value “0” = do not use. |
| 0-1 | P2P Discovery rank |
| 2-3 | NAN Discovery rank |
| 4-5 | AP Infrastructure Discovery rank |
| 6-7 | BLE Discovery rank |
| 8-9 | NFC Discovery rank |
| 10-11 | P2P Connectivity rank |
| 12-13 | AP Infrastructure rank |
| 14 | ASP session over IP (1: ASP session over IP, |
| | 0: ASP session over non-IP) |
| 14-31 | Reserved for future extension |

The disclosed embodiments may be implemented on software, hardware or a combination of software and hardware. Certain embodiments of the disclosure are implemented as logic on one or more processor circuitry configured with appropriate instructions. Certain embodiments of the disclosure may be implemented at a server, an AP or at a device capable of wireless communication.

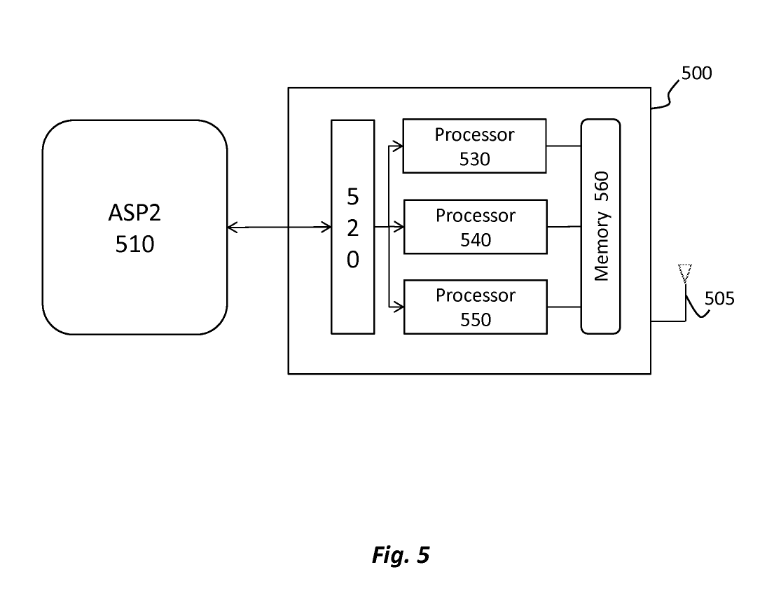

FIG. 5 shows an exemplary apparatus for implementing an embodiment of the disclosure. Apparatus 500 of FIG. 5 includes API 520, processor circuitries 530, 540 and 550 as well as memory 560. Apparatus 500 may optionally include one or more antenna(s) 505 to communication with one or more respective radios (not shown) to process analog communication to digital data streams and vice-versa. Apparatus 500 may be associated or integrated with a mobile device. Memory 560 may store instructions to be implemented on one or more of processors 530, 540 and 550. In one embodiment, each processor may define a firmware including the requisite instructions to thereby obviate the need for memory 560. Each of processors 530, 540 or 550 may define one or more actual or virtual processor. In one embodiment, one or more of processors 530, 540 and 550 defines a processor module. Apparatus 500 may be part of a chipset configured to conduct the desired. In one embodiment, ASP2 510 is independent from apparatus 500. In another embodiment, ASP2 510 may be integrated with apparatus 500 on a single chipset or processor. ASP2 510 may define ASP2 or ASP.

Interface (API) 520 may define a programming primitive(s) or an API for an application service platform. Interface 520 may include Discovery Abstraction, Connectivity Management and Security modes discussed in relation to FIG. 3. Interface 520 may be programmed according to the above-discussed exemplary options. Interface 520 may communicate with one or more of processors 530, 540 and 550. For example, interface 520 may instruct processor 530 on discovery preferences by instructing processor 530 to engage in exclusive, inclusive or ranked discovery modes. In an exemplary embodiment, API 530 may instruct processor 530 to engage in P2P discovery. If P2P discovery is unavailable, interface 530 may instruct processor 530 to engage in BLE discovery. In furthering the discovery mode, processor 530 as well as other processors may engage a corresponding communication platform (not shown). For example, if BLE discovery mode is selected, processor 530 may engage BLE communication mode (not shown) associated with the mobile device hosting apparatus 500.

Once one of P2P or BLE discoveries are engaged and result in discovering a nearby platform (e.g., another mobile device, a printer, a display device, etc.), processor 530 may report such discovery to interface 520. Interface 520 may then direct processor 540 to connect with the discovered device (e.g., a second mobile device) using the preferred connection mechanism. The preferred connection mechanism may be selected as part of the inclusive, inclusive or ranked selection embodiments. For example, API 520 may instruct processor 540 to use P2P connectivity based on a successful P2P discovery by processor 530. Interface 520 may also instruct processor 550 as to security mechanism to be used for the pending connection. Each of processors 540 and 550 may communicate with API 520 to report progress or obtain additional information. In an exemplary embodiment, the bitmaps discussed in relation to TABLES 1, 2, 3 and FIG. 4 may be included in API 520 s or primitives that are passed to ASP 510 by Applications and Services (not shown).

The processors may implement the desired logic at the MAC layer or at layers above MAC layer. For example, in the computer system implementation, it may be implemented at the Operation System (OS).

The following illustrative examples are presented to further illustrates various exemplary embodiments of the disclosure. Example 1 is directed to a method comprising: presenting, by a logic implemented at a MAC layer processor, a user interface during presentation of a first application services platform (ASP) at a first mobile device, wherein the first ASP of the first mobile device provides one of a plurality of configurable options for selecting one of discovery, connectivity and/or network type; receiving, via the user interface, a selection indication corresponding to selection of one of the configurable options to indicate a discovery, connectivity and/or network option; and applying, by the logic, the selected discovery, connectivity and/or network option to the mobile device.

Example 2 is directed to the method of example 1, wherein the user interface configures an ASP2 communication session between the first mobile device and a second mobile device.

Example 3 is directed to the method of any previous example, wherein the user interface configures the first mobile device to select one or more of connectivity, topology and network connection modes.

Example 4 is directed to the method of any previous example, further comprising selecting one or more of discovery, connection and network mode to accommodate an underlying application or services.

Example 5 is directed to the method of any previous example, wherein the selection indication includes all available configurable options for one or more of discovery, connectivity, network or security modes.

Example 6 is directed to the method of any previous example, wherein the selection indication excludes all available configurable options and requires an indicia expressly selecting one or more modes associated with one or more of discovery, connectivity, network or security modes.

Example 7 is directed to the method of any previous example, wherein the selection indication comprises a preference ranking for each available configurable options for one or more of discovery, connectivity, network or security modes.

Example 8 is directed to the method of any previous example, further comprising providing a two-byte bitmap to indicate preference ranking.

Example 9 is directed to the method of any previous example, wherein the selection indication comprises a bitmap to select one or more available configurable options for discovery, connectivity, network or security modes.

Example 10 is directed to the method of any previous example, wherein the logic is implemented at an operation system (OS).

Example 11 is directed a tangible machine-readable non-transitory storage medium that contains instructions, which when executed by one or more processors result in performing operations comprising: presenting, by a logic implemented at a MAC layer processor, a user interface during presentation of a first application services platform (ASP) at a first mobile device, wherein the first ASP of the first mobile device provides one of a plurality of configurable options for selecting one of discovery, connectivity and/or network type; receiving, via the user interface, a selection indication corresponding to selection of one of the configurable options to indicate a discovery, connectivity and/or network option; and applying, by the logic, the selected discovery, connectivity and/or network option to the mobile device.

Example 12 is directed to the tangible machine-readable non-transitory storage medium of example 11, wherein the instructions further cause the user interface to configure an ASP2 communication session between the first mobile device and a second mobile device.

Example 13 is directed to the tangible machine-readable non-transitory storage medium of example 11, wherein the instructions further cause the user interface to configure the first mobile device to select one or more of connectivity, topology and network connection modes.

Example 14 is directed to the tangible machine-readable non-transitory storage medium of example 13, further comprising selecting one or more of discovery, connection and network mode to accommodate an underlying application or services.

Example 15 is directed to the tangible machine-readable non-transitory storage medium of example 11, wherein the selection indication includes all available configurable options for one or more of discovery, connectivity, network or security modes.

Example 16 is directed to the tangible machine-readable non-transitory storage medium of example 11, wherein the selection indication excludes all available configurable options and requires an indicia expressly selecting one or more modes associated with one or more of discovery, connectivity, network or security modes.

Example 17 is directed to the tangible machine-readable non-transitory storage medium of example 11, wherein the selection indication comprises a preference ranking for each available configurable options for one or more of discovery, connectivity, network or security modes.

Example 18 is directed to the tangible machine-readable non-transitory storage medium of example 17, further comprising providing a two-byte bitmap to indicate preference ranking.

Example 19 is directed to the tangible machine-readable non-transitory storage medium of example 11, wherein the selection indication comprises a bitmap to select one or more available configurable options for discovery, connectivity, network or security modes.

Example 20 an apparatus, comprising: a processor circuitry and a memory circuitry to communicate with the processor circuitry, the memory circuitry to contain a set of instructions to cause the processor circuitry to: present a user interface during presentation of a first application services platform (ASP) at a first mobile device, wherein the first ASP of the first mobile device provides one of a plurality of configurable options for selecting one of discovery, connectivity and/or network type; receive, via the user interface, a selection indication corresponding to selection of one of the configurable options to indicate a discovery, connectivity and/or network option; and apply, by the logic, the selected discovery, connectivity and/or network option to the mobile device.

Example 21 is directed to the apparatus of any previous example, wherein the processor circuitry is a logic implemented at a MAC layer processor or at the operating system (OS).

Example 22 is directed to the apparatus of any previous example, wherein the set of instructions further cause the processor circuitry to configure an ASP2 communication session between the first mobile device and a second mobile device.

Example 23 is directed to the apparatus of any previous example, wherein the set of instructions further cause the processor circuitry to configure the first mobile device to select one or more of connectivity, topology and network connection modes.

Example 24 is directed to the apparatus of any previous example, wherein the selection includes all available configurable options for one or more of discovery, connectivity, network or security modes.

Example 25 is directed to the apparatus of any previous example, wherein the selection excludes all available configurable options and requires an indication to expressly selecting one or more modes associated with one or more of discovery, connectivity, network or security modes.

Example 27 is directed to the apparatus of any previous example, wherein the selection indication comprises a preference ranking for each available configurable options for one or more of discovery, connectivity, network or security modes.

Example 28 is directed to the apparatus of any previous example, wherein the processor circuitry is a logic configured to provide a two-byte bitmap to indicate preference ranking.

While the principles of the disclosure have been illustrated in relation to the exemplary embodiments shown herein, the principles of the disclosure are not limited thereto and include any modification, variation or permutation thereof.

What is claimed is:

1. A method comprising:
presenting, by a logic implemented at a MAC layer processor, a user interface during presentation of a first application services platform (ASP) at a first mobile device, wherein the first ASP of the first mobile device provides one of a plurality of configurable options for selecting one of discovery, connectivity and/or network type;
receiving, via the user interface, a selection indication corresponding to selection of one of the configurable options to indicate a discovery, connectivity and/or network option; and
applying, by the logic, the selected discovery, connectivity and/or network option to the mobile device.

2. The method of claim 1, wherein the user interface configures an ASP2 communication session between the first mobile device and a second mobile device.

3. The method of claim 1, wherein the user interface configures the first mobile device to select one or more of connectivity, topology and network connection modes.

4. The method of claim 3, further comprising selecting one or more of discovery, connection and network mode to accommodate an underlying application or services.

5. The method of claim 1, wherein the selection indication includes all available configurable options for one or more of discovery, connectivity, network or security modes.

6. The method of claim 1, wherein the selection indication excludes all available configurable options and requires an indicia expressly selecting one or more modes associated with one or more of discovery, connectivity, network or security modes.

7. The method of claim 1, wherein the selection indication comprises a preference ranking for each available configurable options for one or more of discovery, connectivity, network or security modes.

8. The method of claim 7, further comprising providing a two-byte bitmap to indicate preference ranking.

9. The method of claim 1, wherein the selection indication comprises a bitmap to select one or more available configurable options for discovery, connectivity, network or security modes.

10. The method of claim 1, wherein the logic is implemented at an operation system (OS).

11. A tangible machine-readable non-transitory storage medium that contains instructions, which when executed by one or more processors result in performing operations comprising:
presenting, by a logic implemented at a MAC layer processor, a user interface during presentation of a first application services platform (ASP) at a first mobile device, wherein the first ASP of the first mobile device provides one of a plurality of configurable options for selecting one of discovery, connectivity and/or network type;
receiving, via the user interface, a selection indication corresponding to selection of one of the configurable options to indicate a discovery, connectivity and/or network option; and
applying, by the logic, the selected discovery, connectivity and/or network option to the mobile device.

12. The tangible machine-readable non-transitory storage medium of claim 11, wherein the instructions further cause the user interface to configure an ASP2 communication session between the first mobile device and a second mobile device.

13. The tangible machine-readable non-transitory storage medium of claim 11, wherein the instructions further cause the user interface to configure the first mobile device to select one or more of connectivity, topology and network connection modes.

14. The tangible machine-readable non-transitory storage medium of claim 13, further comprising selecting one or more of discovery, connection and network mode to accommodate an underlying application or services.

15. The tangible machine-readable non-transitory storage medium of claim 11, wherein the selection indication includes all available configurable options for one or more of discovery, connectivity, network or security modes.

16. The tangible machine-readable non-transitory storage medium of claim 11, wherein the selection indication excludes all available configurable options and requires an indicia expressly selecting one or more modes associated with one or more of discovery, connectivity, network or security modes.

17. The tangible machine-readable non-transitory storage medium of claim 11, wherein the selection indication comprises a preference ranking for each available configurable options for one or more of discovery, connectivity, network or security modes.

18. The tangible machine-readable non-transitory storage medium of claim 17, further comprising providing a two-byte bitmap to indicate preference ranking.

19. The tangible machine-readable non-transitory storage medium of claim 11, wherein the selection indication comprises a bitmap to select one or more available configurable options for discovery, connectivity, network or security modes.

20. An apparatus, comprising: a processor circuitry and a memory circuitry to communicate with the processor circuitry, the memory circuitry to contain a set of instructions to cause the processor circuitry to:
present a user interface during presentation of a first application services platform (ASP) at a first mobile device, wherein the first ASP of the first mobile device provides one of a plurality of configurable options for selecting one of discovery, connectivity and/or network type;
receive, via the user interface, a selection indication corresponding to selection of one of the configurable options to indicate a discovery, connectivity and/or network option; and
apply, by the logic, the selected discovery, connectivity and/or network option to the mobile device.

21. The apparatus of claim 20, wherein the processor circuitry is a logic implemented at a MAC layer processor or at the operating system (OS).

22. The apparatus of claim 20, wherein the set of instructions further cause the processor circuitry to configure an ASP2 communication session between the first mobile device and a second mobile device.

23. The apparatus of claim 20, wherein the set of instructions further cause the processor circuitry to configure the first mobile device to select one or more of connectivity, topology and network connection modes.

24. The apparatus of claim 23, wherein the selection includes all available configurable options for one or more of discovery, connectivity, network or security modes.

25. The apparatus of claim 23, wherein the selection excludes all available configurable options and requires an indication to expressly selecting one or more modes associated with one or more of discovery, connectivity, network or security modes.

27. The apparatus of claim 23, wherein the selection indication comprises a preference ranking for each available configurable options for one or more of discovery, connectivity, network or security modes.

28. The apparatus of claim 20, wherein the processor circuitry is a logic configured to provide a two-byte bitmap to indicate preference ranking.
